(19) United States
(12) Patent Application Publication
(10) Pub. No.: US 2025/0162364 A1
(43) Pub. Date: May 22, 2025

(54) GLADHAND COUPLING WITH PRESSURE SENSING MODULE

(71) Applicant: Robotic Research OpCo, LLC, Clarksburg, MD (US)

(72) Inventors: Steven Rotundo, Baltimore, MD (US); Alberto Daniel Lacaze, Potomac, MD (US)

(21) Appl. No.: 18/906,539

(22) Filed: Oct. 4, 2024

Related U.S. Application Data
(60) Provisional application No. 63/600,168, filed on Nov. 17, 2023.

(51) Int. Cl. B60D 1/64; B25J 9/16

(52) U.S. Cl. CPC B60D 1/64; B25J 9/1679

(57) ABSTRACT

A method includes positioning a gladhand coupler of a vehicle adjacent a gladhand receptacle of a trailer, delivering pressurized fluid through a pneumatic channel and out a pneumatic port of the gladhand coupler to impinge upon the gladhand receptacle, detecting, with a pressure sensor, back pressure of the delivered fluid reflected off the gladhand receptacle, determine a location of a pneumatic port of the gladhand receptacle based at least in part on one of a detected threshold pressure, detected pressure differential or detected pressure change of the back pressure to enable alignment of the pneumatic port of the gladhand coupler relative to the pneumatic port of the gladhand receptacle and coupling the gladhand coupler to the gladhand receptacle.

### CROSS REFERENCE TO RELATED APPLICATIONS

The present application claims priority to, and the benefit of, U.S. Provisional Application Ser. No. 63/296,907, filed Dec. 23, 2023, and entitled GLADHAND COUPLING WITH PRESSURE SENSING MODULE, the contents of such disclosure being incorporated herein by its entirety.

### FIELD

The present disclosure relates generally to tractor-trailer systems, and more particularly, relates to coupling between a truck and a semi-trailer system, for example, gladhand couplers for trailer pneumatic brakes.

### BACKGROUND

An 18-wheeler or tractor-trailer truck includes a semi-trailer (also referred to herein as “trailer”) releasably coupled to a tractor (also referred to herein as “truck” or “vehicle”). At distribution centers, marine terminals, rail heads, etc., the trailer is often disconnected from the truck, for example, for cargo loading, cargo unloading, storage, or changing between trucks. In such locations, rather than the truck used for road hauling, the trailer can be moved about by a specialized local tractor (also referred to herein as “hostler,” “hostler truck,” “yard truck,” “yard dog,” “terminal tractor,” “shuttle truck,” or “shunt truck”). However, trailers have a pneumatic parking brake (also referred to as “spring brake” or “emergency brake”) that mechanically engage when the tractor's pressurized pneumatic lines are disconnected (e.g., via gladhand couplers on the trailer). Thus, to allow movement of the trailer by the hostler, the trailer parking brake has to be disengaged by pressurizing the pneumatic lines. This requires manually connecting pneumatic lines between the hostler and the trailer, as automatic connection tends to be difficult or subject to failure. Not only does manual connection of pneumatic lines require additional time and subject a user to potential risk, but it also limits the adoption of semiautonomous or automation (e.g., automating operation of the hostler to move trailers) at such locations. Embodiments of the disclosed subject matter may address one or more of the above-noted problems and disadvantages, among other things.

### SUMMARY

Embodiments of the disclosed subject matter provide systems, methods, and devices for semi-autonomous, assisted teleoperation operation or autonomous (e.g., remote controlled but without human contact with the gladhand) connection of pneumatic supply lines via gladhand couplings. In some embodiments, a method comprises positioning a gladhand coupler of a vehicle adjacent a gladhand receptacle of a trailer, delivering pressurized fluid through a pneumatic channel and out a pneumatic port of the gladhand coupler to impinge upon the gladhand receptacle, detecting, with a pressure sensor, back pressure of the delivered fluid reflected off the gladhand receptacle, determine a location of a pneumatic port of the gladhand receptacle based at least in part on one of a detected threshold pressure, detected pressure differential or detected pressure change of the back pressure to enable alignment of the pneumatic port of the gladhand coupler relative to the pneumatic port of the gladhand receptacle, and coupling the gladhand coupler to the gladhand receptacle.

In embodiments, the method includes coupling an end effector to a robotic arm with the end effector including the gladhand coupler. In some embodiments, coupling the gladhand coupler to the gladhand receptacle includes aligning the pneumatic ports of the gladhand coupler and the gladhand receptacle. In illustrative embodiments, coupling the gladhand coupler to the gladhand receptacle includes engaging pneumatic seals of the gladhand coupler and the gladhand receptacle.

In embodiments, detecting the location of the pneumatic port of the gladhand receptacle includes identifying a seal aperture of the pneumatic seal of the gladhand receptacle based on the one of the detected threshold pressure, detected pressure differential or detected pressure change of the back pressure. In some embodiments, coupling the gladhand coupler to the gladhand receptacle is performed semi-autonomously with the robotic arm.

In some embodiments, coupling the gladhand coupler to the gladhand receptacle is performed autonomously with the robotic arm. In illustrative embodiments, controlling movement of the robotic arm is based at least in part of pressure data detected by the pressure sensor.

In embodiments, the method includes verifying a sealed relationship of the engaged pneumatic seals of the gladhand coupler and the gladhand receptacle.

In some embodiments, the method includes releasing the end effector from the robotic arm.

In another illustrative embodiment of the present invention, a method comprises coupling an end effector to a robotic arm where the end effector includes a gladhand coupler defining a first pneumatic channel and a first pneumatic port for passage of pressurized air from a pressurized or pneumatic line of a vehicle, and having a first pneumatic seal defining a first seal opening surrounding the first pneumatic port, moving the robotic arm to position the end effector adjacent a gladhand receptacle of a trailer where the gladhand receptacle has a second pneumatic seal defining a second seal opening surrounding a second pneumatic port of the gladhand receptacle, delivering pressurized air from the pressurized or pneumatic line through the first pneumatic channel and out the first pneumatic port of the gladhand coupler to impinge upon the gladhand receptacle, detecting, with a pressure sensor, back pressure of the delivered air, identifying a location of the second seal opening of the pneumatic seal of the gladhand receptacle based at least in part on one of a threshold pressure, pressure differential or pressure change of the detected back pressure, aligning the first pneumatic port of the gladhand coupler with the second pneumatic port of the gladhand receptacle, and coupling the gladhand coupler to the gladhand receptacle whereby the first and second pneumatic seals establish a sealed relation.

In some embodiments, the method includes releasing the end effector from the robotic arm.

In embodiments, the method includes moving the end effector relative to the gladhand receptacle.

In some embodiments, the method includes obtaining multiple pressure measurements with the pressure sensor.

In embodiments, at least one of the steps is performed by a processor and a memory coupled to the processor.

In another illustrative embodiment of the present invention, a gladhand coupler system for attachment to a gladhand of a trailer comprises a robotic apparatus including at least one robotic arm and having an end effector coupled to the robotic arm, a gladhand coupler mounted to the end effector of the robotic system, a pneumatic channel extending at least through the gladhand coupler and terminating in a pneumatic port for delivering pressurized fluids from the port toward the gladhand receptacle of the trailer, a pressure sensor module including a pressure sensor for detecting back pressure of the pressurized fluids reflected off the gladhand receptacle, an electronic processing device and a non-transitory computable-reading medium storing instruction that when executed by the electronic processing device results in: i) activating the at least one robotic arm to move the end effector to position the gladhand coupler adjacent the gladhand receptacle of the trailer; and ii) adjusting a location of the gladhand coupler via the at least one robotic arm based at least in part on a detected back pressure of the pressurized fluids off the gladhand receptacle detected by the pressure sensor.

In embodiments, the instructions, when executed by the electronic processing device, further results in identifying a seal aperture of the pneumatic seal of the gladhand receptacle based on the detected back pressure.

In some embodiments, the instructions, when executed by the electronic processing device, further results in manipulating the at least one robotic arm and the end effector to align pneumatic ports of the gladhand coupler and the gladhand receptacle.

In other embodiments, the instructions, when executed by the electronic processing device, further results in coupling, by the at least one robotic arm and the end effector, the gladhand coupler to the gladhand receptacle.

In embodiments, coupling the gladhand coupler includes engaging pneumatic seals of the gladhand coupler and the gladhand receptacle.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Where applicable, some elements may be simplified or otherwise not illustrated in order to assist in the illustration and description of underlying features. Throughout the figures, like reference numerals denote like elements. An understanding of embodiments described herein and many of the attendant advantages thereof may be readily obtained by reference to the following detailed description when considered with the accompanying drawings, wherein:

FIGS. 1A-1C shows a truck coupled to a semi-trailer, a trailer supply connector station, and a gladhand receptacle, respectively, in a conventional tractor-trailer system;

FIGS. 2A-2D shows various stages for coupling a vehicle to a semi-trailer, including gladhand coupling via a robotic arm assembly, according to one or more illustrative embodiments of the disclosed subject matter;

FIG. 3 illustrates a sequence of coupling an end effector of a vehicle to a gladhand receptacle of a trailer based in part on pressure readings obtained by a pressure sensor and associated sensor module, according to one or more illustrative embodiments of the disclosed subject matter;

FIGS. 4A-4B are simplified cross-sectional views of an end effector with a gladhand coupling with the end effector in initial positioning and secured configurations, respectively, relative to the gladhand receptacle of the trailer, according to one or more illustrative embodiments of the disclosed subject matter;

FIGS. 4C-4D are simplified cross-sectional views of an end effector with a gladhand coupling with the end effector in initial positioning and secured configurations, respectively, relative to the gladhand receptacle of the trailer, according to one or more illustrative embodiments of the disclosed subject matter;

FIG. 5 is a process flow diagram of an exemplary method for coupling a an end effector with a gladhand coupling to a gladhand receptacle of a trailer, according to one or more illustrative embodiments of the disclosed subject matter;

FIG. 6 is a simplified schematic diagram of a vehicle system with semi-autonomous or autonomous gladhand coupling, according to one or more illustrative embodiments of the disclosed subject matter; and

FIG. 7 depicts a generalized example of a computing environment in which the disclosed technologies may be implemented.

### DETAILED DESCRIPTION

### I. Introduction

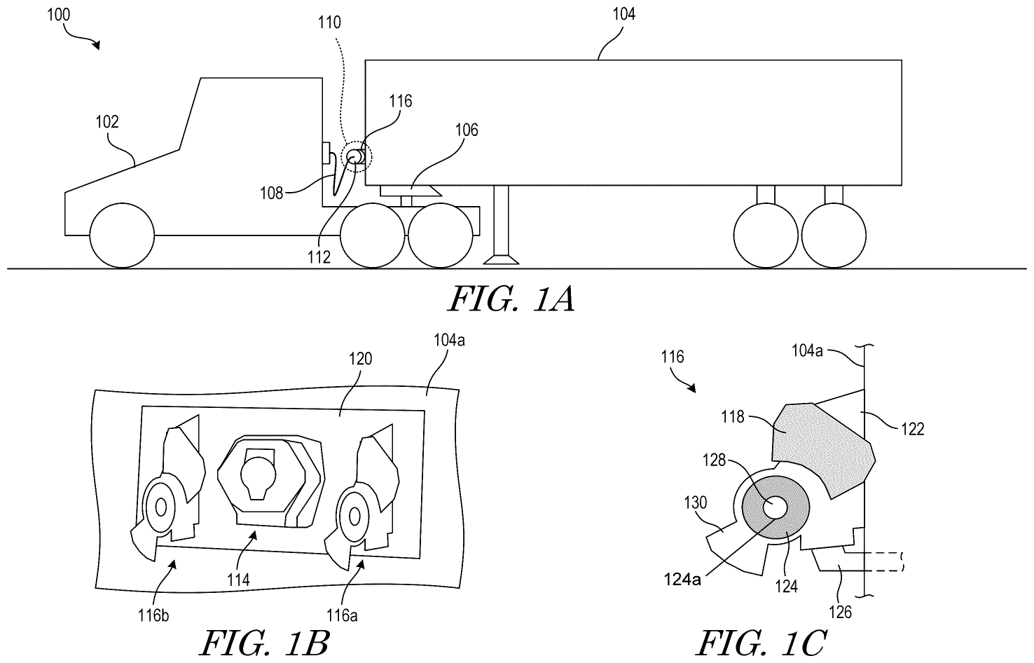

With initial reference to FIGS. 1A-1C, in a tractor-trailer system 100 (e.g., an 18-wheeler or tractor-trailer truck), a semi-trailer 104 (also referred to herein as “trailer”) is releasably coupled to a vehicle 102 (also referred to herein as “truck” or simply “vehicle”) via a fifth-wheel connector 106, as shown in FIG. 1A. A supply coupling 110 between the vehicle 102 and the trailer 104 is used to provide the braking system of the trailer 104 with pressurized air (e.g., via pneumatic line 108) from the vehicle 102 and/or the electrical system of the trailer 104 with power from the vehicle 102. In North America, there are usually two gladhand receptacles 116 corresponding to two separate pneumatic lines of the trailer 104. One gladhand receptacle 116a (and corresponding pneumatic line) is pressurized to release the brake drums of the trailer 104 that otherwise provides a fail-safe state (e.g., with the brakes applied to the trailer). The other gladhand receptacle 116b (and corresponding pneumatic line) is used as the service brakes to assist the braking provided by wheels of the vehicle 102. The application of pressure to the pneumatic lines is typically controlled by the tractor driver, e.g., either a human driver or an autonomous control unit (e.g., via a drive-by-wire system).

As shown in FIG. 1B, a connector station 120 can be mounted on or part of a front-facing surface 104a of the trailer 104. The connector station 120 can have separate gladhand receptacles 116a, 116b flanking opposite lateral sides of an electrical receptacle 114, via which power can be applied to the electrical system of the trailer 104. In some embodiments, each gladhand receptacle 116 can extend from the trailer 104 along a longitudinal direction of the system 100 (e.g., from the trailer front surface 104a toward the vehicle 102), as shown in FIGS. 1B-1C.

Gladhand are designed to comply with one or more industry standards, such as Society of Automotive Engineers (SAE) J318_202106, “Automotive Air Brake Line Couplers (Gladhand),” J318_202106, published Jun. 10, 2021, and/or International Organization for Standardization (ISO) 1728:2006, “Road vehicles-Pneumatic braking connections between motor vehicles and towed vehicles-Interchangeability,” published September 2005, both of which are incorporated herein by reference. Different colors may be used to indicate gladhand and/or pneumatic lines corresponding to the service and emergency brakes (e.g., blue and red, respectively). In general, the same connector configuration may be used for the gladhand for each pneumatic line.

For example, as shown in FIG. 1C, each gladhand receptacle 116 can have an alignment member 118, a mounting member 122, a sealing member 124 defining a seal aperture or opening 124a, a pneumatic port 128, and a detent plate 130. The gladhand receptacle 116 can be coupled to the trailer 104 (directly to the front surface 104a or indirectly via one or more intervening members) by mounting member 122. The alignment member 118 can be designed to interface with a cam flange (e.g., detent plate) of the standard gladhand coupler 112 to help position and retain the gladhand coupler thereto. A pneumatic line 126 can be fluid communication with the trailer braking system and the pneumatic port 128. When connected to the gladhand coupler 112, the sealing member 124 (e.g., gasket) of the receptacle 116 can interface with a corresponding member or surface, (for example, a seal) of the gladhand coupler 112 of the vehicle to seal the area surrounding the pneumatic port 128, such that pressurized air from the gladhand coupler 112 can be provided to the trailer braking system via the pneumatic port 128 and pneumatic line 126.

Coupling a gladhand coupler 112 of a vehicle to a gladhand receptacle 116 of a trailer in conventional systems requires a human to manually connect and disconnect the pneumatic lines; however, such configurations may not be conducive to a partially or fully autonomous operation. Although trailers may be designed with new versions of gladhand receptacles that are easier to autonomously connect, a large number of trailers in operation have been built and will continue to be built with conventional gladhand configurations. Disclosed herein are tractor-trailer systems, configurations, and methods that facilitate autonomous (semi-autonomous, assisted teleoperated operation or automated) operation, for example, transport via an autonomous vehicle (e.g., truck, tractor or hostler). In some embodiments, the vehicle coupled to the trailer is an autonomous truck or vehicle, for example, a yard hostler. In some embodiments, the features of the tractor and/or the system can reduce the amount of manual intervention and/or human oversight required for transport of the trailer. In embodiments, the system can facilitate alignment of the gladhand components of the tractor and the trailer. In other embodiments, the system may provide an indication that the coupling engagement is properly effected.

In some embodiments, the existing gladhand receptacle on the trailer (or on the truck or another trailer) can be retained, while the gladhand coupler that connects thereto can be modified to allow for robotic or automated positioning and coupling.

In some embodiments, an autonomous gladhand coupling system can employ a robotic arm assembly (e.g., having one or more robotic arms, one or more linear actuators, and/or one or more support cables) and a detachable end effector at an end of the arm assembly. The detachable end effector includes a gladhand coupler integrated therewith, and can be configured to mate with the existing gladhand receptacle of the trailer. For example, the vehicle can have a single linearly-actuatable arm with a detachable end effector that is extendable from a rear of a tractor toward the gladhand receptacle on the trailer (or on the front of a trailer extendable toward a gladhand receptacle on a truck, or on the rear of a first trailer extendable toward a gladhand receptacle on a second trailer). Alternatively or additionally, one or more parallel robotic arms with an end effector can be removably attached on a mounting surface at an end of one or more parallel robotic arms extending from a rear of the vehicle.

In some embodiments, the autonomous gladhand coupling system can be integrated with the vehicle (e.g., where the truck is manufactured with the linear arm built in), or it can be an aftermarket add-on to the vehicle (e.g., as a modular unit coupled to a rear of the truck). Similarly, when the autonomous gladhand coupling system is on the trailer, it can be integrated with the trailer (e.g., where the trailer is manufactured with the linear arm built in), or it can be an aftermarket add-on to the trailer (e.g., as a modular unit coupled to a front or rear sidewall of the trailer).

In embodiments, the system includes a pressure sensor module for facilitating alignment of the gladhand components of the vehicle and the trailer. The pressure sensor module includes one or more pressure sensors capable of detecting a threshold pressure, a pressure differential or change across the surfaces of the gladhand components during manipulation of the gladhand coupler of the vehicle relative to the gladhand receptacle of the trailer. The detected pressure change is utilized to facilitate and/or confirm proper alignment, including depth (longitudinal) and lateral alignment of the gladhand components.

### II. Gladhand Coupling Via Robotic Arm Assembly

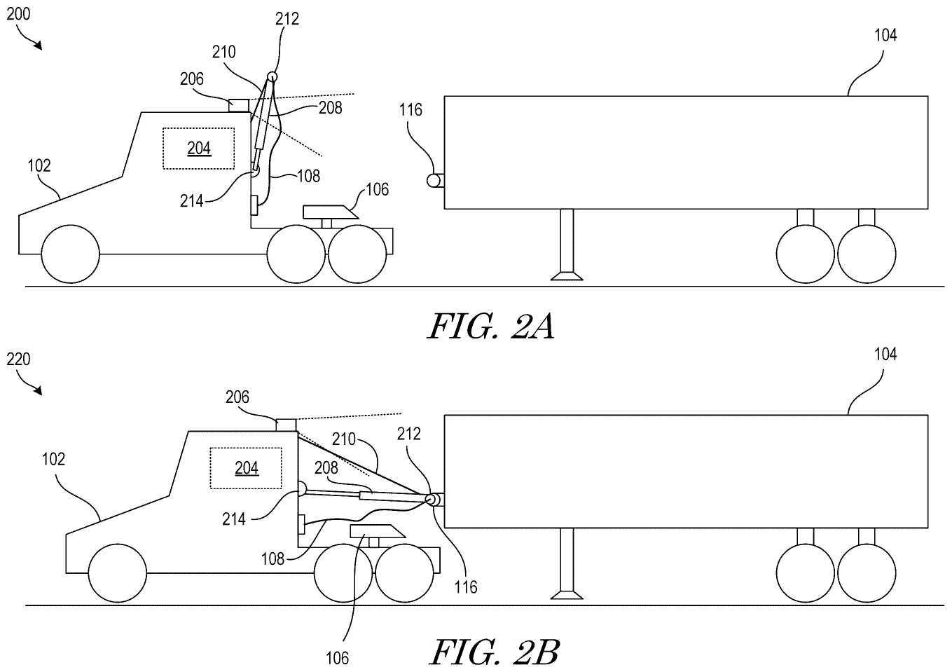

In some embodiments, a robotic arm 208 can be used to autonomously couple a pneumatic line(s) 108 from a vehicle 202 to a gladhand receptacle 116 of a trailer 104, for example, as shown in FIGS. 2A-2D. In some embodiments, the vehicle 202 is an autonomous vehicle, for example, with a control system 204 for controlling operation of the vehicle 202. In some embodiments, the control system 204 may also control operation of the gladhand coupling system, for example, to control movement of the robotic arm assembly for positioning an end effector 212 with respect to the gladhand receptacle 116, to control actuation of the end effector 212 to engage the gladhand receptacle 116, and/or to control movement of the robotic arm assembly without end effector 212 to a stowed position. Alternatively, in some embodiments, a control system for controlling operation of the robotic arm assembly can be separate from and/or communicate with a control system 204 for controlling vehicle operation.

In some embodiments, the vehicle 202 and/or gladhand coupling system can be provided with one or more sensors, for example, to detect a type, location, and/or orientation of the gladhand receptacle 116 and/or a location of the end effector 212 (e.g., during positioning and/or after positioning, for example, to retrieve the end effector 212 when the trailer 104 is being decoupled from the vehicle 202). For example, a sensor 206 can be provided on a cabin roof of the vehicle 202 and can have a rearward-facing field-of-view for detecting aspects of the gladhand receptacle 116. Other locations for sensor 206 are also possible, such as but not limited to a rear surface of the vehicle cabin, a side surface of the vehicle cabin, and a portion of the vehicle body supporting the fifth-wheel connector 106.

In the illustrated example of FIGS. 2A-2D, the robotic arm assembly includes a telescopic robotic arm 208. A first end of the robotic arm 208 can be coupled to the vehicle 202 (e.g., at a rear of a cabin of the vehicle) by a pivot 214 (e.g., universal joint). Alternatively, in some embodiments, the pivot 214 can be mounted at different locations on the vehicle 202, such as but not limited to a side of the vehicle cabin or a part of the rear frame between the fifth-wheel connector and the cabin. The end effector 212 can be releasably mounted to a second end of the robotic arm 208 opposite the first end, and at least two position control members 210 (e.g., support cables, wires, tethers, or any other control elements) can be coupled to the robotic arm 208 in a region between the pivot 214 and the end effector 212 (e.g., closer to the second end of the robotic arm 208 than to the first end). In some embodiments, the change in length of the robotic arm 208 together with changes in respective lengths of the at least two position control members 210 can operate to position the end effector 212 with three degrees of freedom. Other mechanisms, without control members 210) for controlling robotic arm 208 are envisioned

During the approach stage 200 of FIG. 2A, a rear end of the vehicle 202 can approach a front end of the trailer 104, with the robotic arm 208 oriented close to the vehicle 202 and with the end effector 212 retained at the second end of the arm 208. During the gladhand coupling stage of FIG. 2B, the vehicle 202 can further approach the trailer 104, and/or the arm 208 can be lowered about pivot 214 and can be moved into position (e.g., via position control members 210) with respect to the trailer gladhand receptacle 116. For example, the arm 208 can be moved such that an air supply outlet of the end effector 212 is aligned with the pneumatic port of the gladhand receptacle 116, after which the supply outlet can be mated with the pneumatic port, for example, by clamping the end effector 212 to the receptacle. Once effectively coupled to the gladhand receptacle 116, the end effector 212 can then be de-coupled from the arm 208, and the arm 208 can be retracted and/or returned to a stowed position, for example, as shown in the stowing stage 230 of FIG. 2C. Finally, the vehicle 102 can further approach the trailer 104 to connect and lock the fifth-wheel connector 106 to the trailer 104, as shown in the trailer attachment stage 240 of FIG. 2D. Air can then be supplied to pneumatic lines 108, such that the emergency brakes on the trailer are released and/or the service brakes are functional. In some embodiments, the reverse steps can be followed when the trailer is decoupled from the vehicle.

### III. End Effector with Pressure Sensor Module

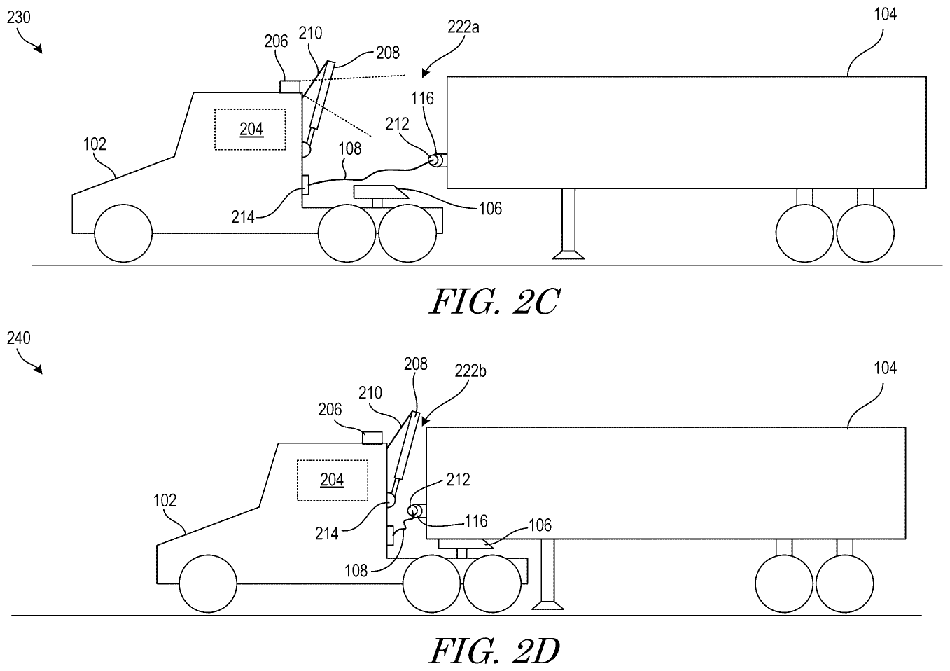

With reference to FIG. 3, in some embodiments, a robotic arm 208 coupled to the vehicle can be used to sequentially or separately connect multiple end effectors 212a, 212b stored on a holder 207, and to move the end effector to respective gladhand receptacles on a trailer. Each of the end effectors 212a, 212b includes or has a gladhand coupler capable of coupling to the respective gladhand receptacles 116a, 116b of a trailer (FIGS. 2A-2D). In embodiments, the gladhand couplers are integrated with the end effectors 212a, 212b. In embodiments, the gladhand couplers are mounted or otherwise secured to the end effectors 212a, 212b. The robotic arm 208 can be used to connect one end effector 212a to a service brake gladhand receptacle on the trailer, and to connect another end effector 212b, in sequence, to an emergency brake gladhand receptacle on the trailer. Alternatively, or additionally, the robotic arm 208 can connect other end effectors to other pneumatic gladhand receptacles (e.g., for air-actuated machinery aboard the trailer) and/or to non-gladhand receptacles (e.g., connectors for electrical power). In embodiments, the robotic arm 208 is moved via position control members 210 (e.g., cables) to engage and grab an end effector 212a, 212b (e.g., via magnetic attraction, vacuum application, mechanical connection, or other means) for coupling to the appropriate gladhand receptacle. FIG. 3 illustrates, in sequence, an initial stage, an end effector selection stage and a gladhand coupling stage.

As depicted in FIG. 3, in embodiments, the vehicle 202 may include a controller 232 for controlling operation of at least the robotic arm 208 and, in embodiments, the control members 210 and other systems of the vehicle 202. The vehicle 202 may further include a vehicle interface 234 to which the pneumatic lines 108 are coupled and a pneumatic source 236 for supplying pressurized air for use by one or more of the end effectors 212a, 212b. In embodiments, the vehicle may include a manifold 238 (e.g., comprising one or more valves), which can direct the pressurized air from source 236 to one or more of the pneumatic lines 108 coupled to vehicle interface 234 for delivery to one of the end effectors 212a, 212b. In some embodiments, operation of the manifold 238 and/or the pneumatic source 236 can be controlled by controller 232, which may be separate from or part of a controller that operates the robotic arm 208 and/or a controller that operates vehicle 702.

In embodiments, a pressure sensor module or subsystem 240 is coupled to or associated with one of the robotic arm 208 and/or the end effector 212a, 212b. The pressure sensor module 240 is configured to facilitate alignment of the end effector 212a, 212b (which includes the gladhand coupler) with the gladhand receptacle 116a, 116b of the trailer 104, by, for example, detecting a pressure change, pressure difference or differential at the gladhand receptacle 116a, 116b of the trailer 104. In embodiments, detecting pressure or detecting a pressure differential along, for example, the surfaces/coupling faces of the gladhand receptacles 116a, 116b may be indicative of proper alignment of the end effector 212a, 212b with the gladhand receptacle 116a, 116b. In embodiments, the pressure sensor module 240 may include one or more pressure sensors or transducers which are coupled to the end effectors 212a, 212b and, in embodiments, in fluid communication with the pneumatic lines 108.

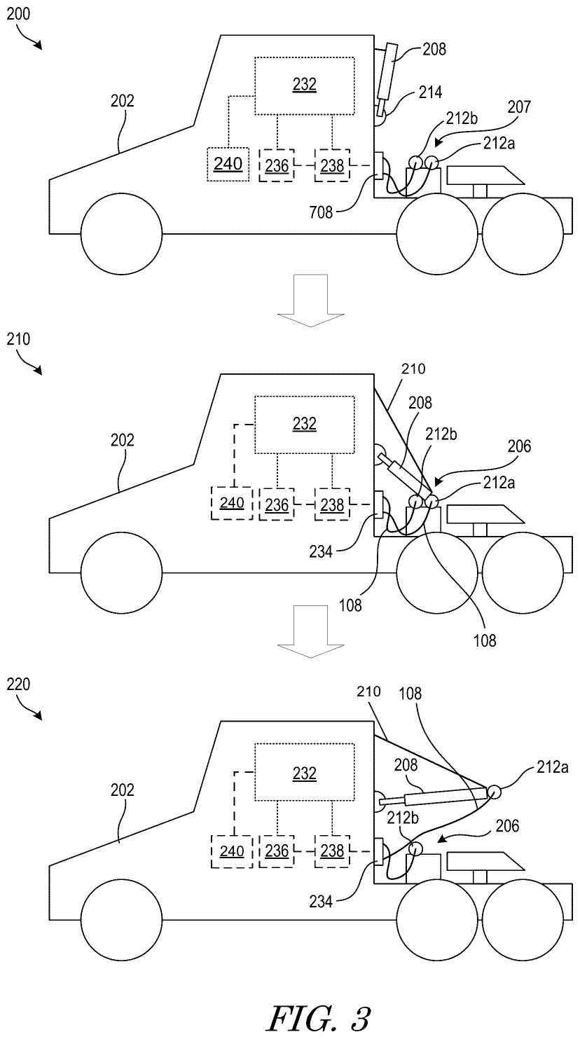

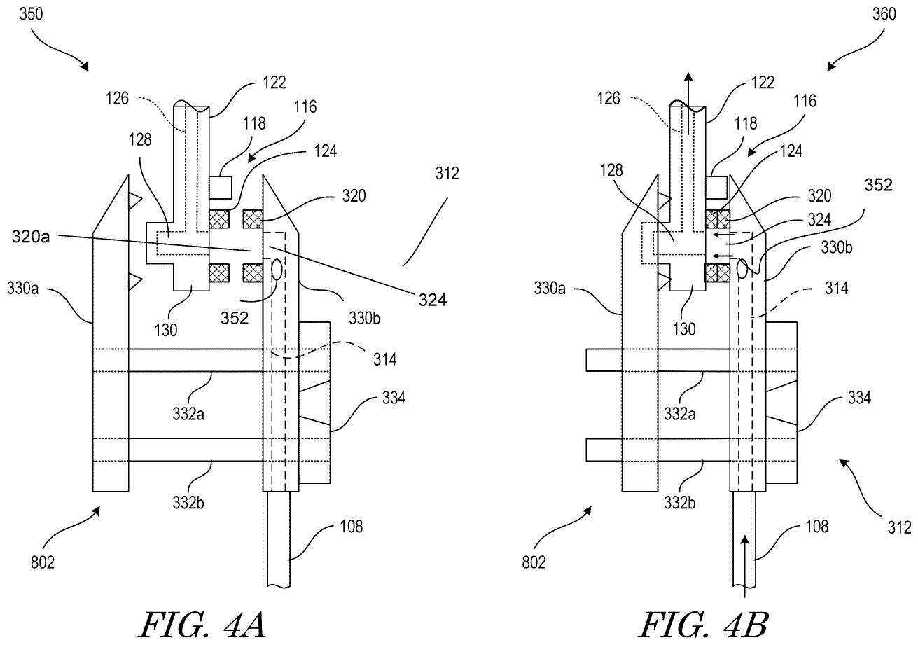

FIGS. 4A and 4B illustrate an exemplary embodiment of an end effector for use with the pressure sensor module 240. In embodiments, the end effector 312 includes an integrated gladhand coupler which is configured to mate with the gladhand receptacle 116 of the trailer 104. In embodiments, the end effector 312 can connect to the existing gladhand receptacle 116 of the trailer 104 via operation of the robotic arm 208. In some embodiments, the end effector 312 is configured to clamp to the gladhand receptacle 116. Other arrangements are also envisioned. In the illustrated example, the end effector 312 employs a clamping mechanism to securely couple to the gladhand receptacle 116, for example, by movement of opposing clamping members 330a, 330b toward (e.g., to couple to the receptacle 116) or away (e.g., to disengage from the receptacle 116) from each other.

In embodiments, the second clamping member 330b of the end effector 312 includes an integrated gladhand coupler for coupling with the gladhand receptacle 116. The end effector 312 includes an annular coupler pneumatic seal 320 defining a central seal aperture 320a through which pressurized air may flow. The end effector 312 is attached to the pneumatic line 108 (e.g., supply air hose) extending from the vehicle (not shown). The end effector 312 defines a channel 314 therethrough in fluid communication with the pneumatic line 108 and terminating in one or more pneumatic ports 324 of the end effector in alignment with the central seal aperture 320a of the coupler pneumatic seal 320.

In embodiments, the gladhand receptacle 116 of the trailer is configured to mate with the end effector 312. As discussed in connection with FIGS. 1A-1C hereinabove, the gladhand receptacle 116 of the trailer may include an annular receptacle seal 124 (e.g., rubber gasket) defining a central seal aperture 124a. The receptacle seal 124 surrounds the pneumatic port 128 of the gladhand receptacle 116, which is in fluid communication with the pneumatic line 126 and the trailer braking system. When connected to the gladhand coupler of the end effector 312, the receptacle seal 124 of the gladhand receptacle 116 can interface with the coupler pneumatic seal 320 of the end effector 312 and seal the area surrounding pneumatic port 128, such that pressurized air from the gladhand coupler of the end effector 312 can be provided to the trailer braking system via pneumatic line 126.

FIGS. 4A-4B illustrate an exemplary coupling operation between an end effector 312 and gladhand receptacle 116, depicting, in sequence, an initial alignment stage 350 (FIG. 4A) and a coupling stage 360 (FIG. 4B). In embodiments, the coupling is effected through operation of the robotic arm 208 via the control system 232. In some embodiments, the clamping members 330a, 330b can be connected together via one or more actuation members 332a, 332b (e.g., screws), and one or more drive motor 334 (e.g., electric motor) can be used to reposition the clamping members 330a, 330b along the actuation members 332a, 332b, for example, to change a distance between the clamping members 330a, 330b and/or to provide a clamping force to the gladhand receptacle 316 of the trailer disposed between the clamping members, as shown in FIG. 4B. Alternatively, in some embodiments, the clamping motion and/or clamping force can be provided via a spring mechanism. In such configurations, an actuator on the end effector or on the robotic arm assembly can be used to hold the clamping members 330a, 330b open against the spring force, for example, during the alignment stage 350 and/or when disconnecting the end effector from the gladhand receptacle 316. In embodiments, after achieving the coupling relation of FIG. 4B the robotic arm can release the end effector 312, i.e., the clamping member 330b, in the manner described hereinabove. In some embodiments, coupling of the end effector 312 is effected manually.

In embodiments, the end effector 312 includes one or more pressure sensors 352. The pressure sensor 352 may be a component of the pressure sensor module or subsystem 240 (FIG. 3). In embodiments, the pressure sensor 352 is in fluid communication with the channel 314 of the end effector 312 which is in fluid communication with pneumatic line 108. In some embodiments, the pressure sensor 352 is positioned adjacent the pneumatic port 324 of the end effector 312. In some embodiments, the pressure sensor 352 is positioned remote from the pneumatic port 324, for example, on the mating faces of the end effector 312 or the gladhand receptacle 116. The pressure sensor 352 may include any piczoresistive sensor, capacitive pressure transducer, pressure transducer, differential pressure transducer, gauge pressure, differential pressure sensor suitable to detect the pressure of fluid, for example, air adjacent the end effector 312, for example, adjacent the mating faces of the end effector 312 and the gladhand receptacle 116 of the trailer. In embodiments, the pressures sensor 352 is configured to detect a pressure difference, a pressure differential and/or a pressure change during movement of the end effector 312 relative to the gladhand receptacle 116 of the trailer during, for example, the coupling procedure. For example, during coupling of the end effector 312 and the gladhand receptacle 116, pressurized air may be delivered through the channel 314 and out the coupler pneumatic port 324 of the end effector 312 to impinge upon the interior surface or mating face of the gladhand receptacle 116 of the trailer. As the end effector 312 traverses the surface of the gladhand receptacle 116, the back pressure of the pressurized air reflected off the face of the gladhand receptacle 116 may be detected, for example, continuously and/or intermittingly, by the pressure sensor 352. The back pressure may change when, for example, the pressurized air contacts different areas of the face of the gladhand receptacle 116. For example, and without limitation, when the pneumatic coupler port 324 of the end effector 312 is aligned with the peripheral area of the receptacle seal 124 of the gladhand receptacle 116 of the trailer, a first back pressure is detected by the pressure sensor 352. When the pneumatic coupler port 324 of the end effector 312 is aligned with the central seal aperture 124a of the receptacle seal 124 in alignment with the pneumatic port 128 of the gladhand receptacle 116, a second back pressure is detected by the pressure sensor 352. In embodiments, the second back pressure is different, and in embodiments, less than the first back pressure due to the void provided by the internal area of the central aperture 124a of the receptacle seal 124 and the pneumatic port 128. This detected difference in pressure, pressure change or pressure differential may be utilized to determine when the end effector 312 is properly aligned, for example, aligned longitudinally or at the proper depth relative to the gladhand receptacle 116 for coupling of the components. In embodiments, the detected pressure may be indicative that the coupler pneumatic port 324 of the end effector 312 and the receptacle pneumatic port 128 of the gladhand receptacle 116 are in proper alignment to be coupled via, for example, manually and/or with assistance of the robotic arm 208.

In embodiments, the pressure sensor 352 may detect back pressure associated with the delivered pneumatic air at other locations adjacent the gladhand receptacle 116 or locations removed from the gladhand receptacle 116 In embodiments, the pressure, pressure change or pressure differential may be tracked while manipulating the robotic arm 208 and the end effector 312 relative to the gladhand receptacle 116 of the trailer. In embodiments, the pressure may be detected during lateral movement of the end effector 312 relative to the gladhand receptacle 116. As the end effector 312 is moved laterally toward the gladhand receptacle 116, the detected pressure may increase. In embodiments, the pressure may be detected as the end effector 312 is moved longitudinally relative to the gladhand receptacle 116 The pressure data collected by the pressure sensor 352 during longitudinal and lateral movement of the end effector 312 may be used as feedback to control operation of the robotic am 208.

FIGS. 4C and 4D illustrate an embodiment in which the end effector 330b includes an alignment member 326 which is received within the pneumatic port 128 of the gladhand receptacle 116. The alignment member 326 depends from the end effector 312 and assists in aligning the pneumatic ports 324, 128 upon movement of the clamping members to the approximated condition of FIG. 4D. The alignment member 326 defines the pneumatic port 324 which is in fluid communication with the channel 314.

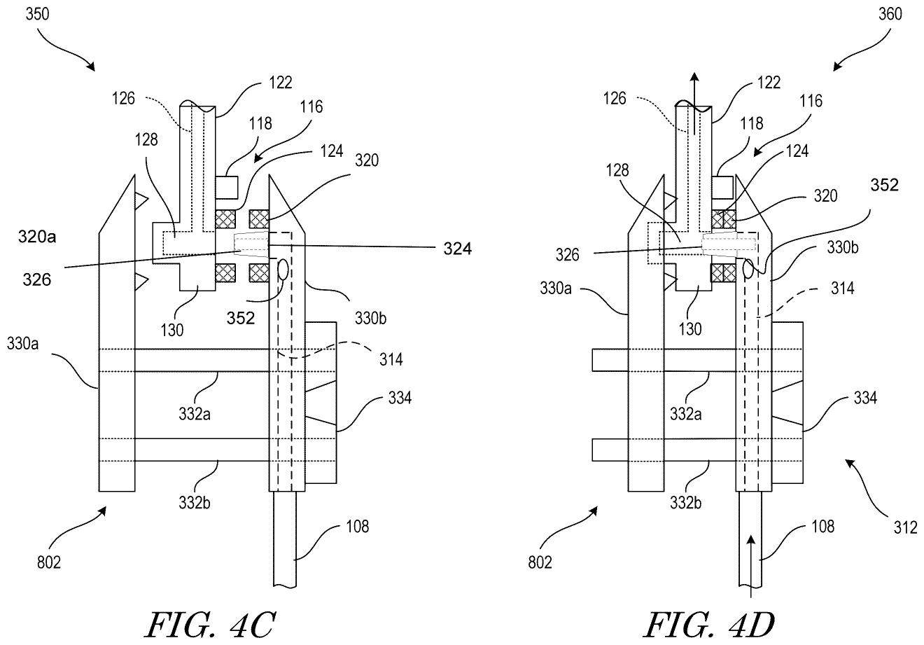

FIG. 5 is a flow chart depicting one illustrative methodology for coupling an end effector 312 having a gladhand coupler to a gladhand receptacle 116 of a trailer. to provide pressurized air to a trailer braking system. The illustrative methodology includes a pressure sensor 352 in association with the pressure sensor module 240. In accordance with one embodiment, the robotic arm 208 engages and couples to a selected end effector 312 mounted or otherwise carried by the vehicle 202. (STEP 402). In STEP 404, the robotic arm 208 controlled via, for example, the control system 232 advances the end effector 312 along a path toward the gladhand receptacle 116 of the trailer. The end effector 312 is positioned generally adjacent the gladhand receptacle 116. In STEP 406, pressurized air is delivered through the pneumatic line 108 and through the one or more pneumatic ports 324 of the end effector 312 The pressurized air impinges against the mating face of the gladhand receptacle 116 of the trailer, and the back pressure of the pressurized gas reflected off the end effector 312 is detected by the pressure sensor 352. (STEP 408). The end effector 312 is moved to traverse the gladhand receptacle 116 and the pressure is continually monitored and/or intermittingly monitored. (STEP 410). In general, the detected pressure will be lower when the pneumatic ports 324, 128 of the end effector 312 and the gladhand receptacle 116 respectively are in general alignment due to the voids provided by the pneumatic ports 324, 128 and the central apertures 124a, 320a of the receptacle seal 124 and the coupler pneumatic seal 320 of the end effector 312. When the pneumatic ports 324, 128 are not aligned, the detected back pressure will be greater. For example, if the pneumatic port 324 of the end effector 312 is facing the peripheral area of the receptacle seal 124 or the internal face of the gladhand receptacle 116, the back pressure will be relatively high. In embodiments, the end effector 312 is moved along the gladhand receptacle 116 and the pressure is monitored by the pressure sensor 352. If the monitored pressure drops, reaches a predefined lower threshold level, and/or achieves a defined pressure differential between pressure readings, it, may be, in embodiments, an indication that the end effector 312 is properly aligned with the gladhand receptacle 116, e.g., the pneumatic ports 324, 128 of end effector and the gladhand receptacle are aligned to be coupled. (STEP 412) In this position, the seal openings 320a, 124a of the pneumatic seals 320, 124 of the end effector 312 and the gladhand receptacle 116 are also aligned. Upon confirmation of proper alignment, the end effector 312 is coupled to the gladhand receptacle 116 of the trailer either manually or through operation of the robotic arm 208. (STEP 414) In some illustrative embodiments, the collected pressure data is utilized by the pressure sensor module 240 and/or the control unit 232 as feedback data to control operation and movement of the robotic arm 208. (STEP 416). In some embodiments, subsequent to coupling of the end effector 312 and the gladhand receptacle 116, the pressures sensor 352 is used to confirm that a proper seal is achieved between the coupler pneumatic seal 320 and the receptacle pneumatic seal 124. (STEP 418). For example, upon proper coupling of the pneumatic seals 320, 124 of the end effector 312 and the gladhand receptacle 116, the pressure may, in embodiments, normalize thereby indicating to the operator that seal integrity has been achieved. Thereafter, the end effector 312 may be released from the robotic arm 208. (STEP 420).

Although illustrated separately, it is contemplated that various process blocks may occur simultaneously or iteratively. Furthermore, certain process blocks illustrated as occurring after others may indeed occur before. Although some of blocks 402-420 of method 400 have been described as being performed once, in some embodiments, multiple repetitions of a particular process block may be employed before proceeding to the next decision block or process block. In addition, although blocks 402-420 of method 400 have been separately illustrated and described, in some embodiments, process blocks may be combined and performed together (simultaneously or sequentially). Moreover, although FIG. 5 illustrates a particular order for blocks 402-420, embodiments of the disclosed subject matter are not limited thereto. Indeed, in certain embodiments, the blocks may occur in a different order than illustrated or simultaneously with other blocks. In some embodiments, method 400 may comprise only some of blocks 402-440 of FIG. 5.

In embodiments, the measurement of backpressure in the air supply, acoustic signature of the air jet impacting the gladhand features, or other means may be used to determine when the jet is positioned in front of the hole in the center of the gladhand receptacle 116 in alignment with the pneumatic port 128 which would indicate proper tool alignment. In the case of a hinged gladhand receptacle 116, the gladhand receptacle 116 might deflect toward the end effector 312 when the pressurized jet of air passes in front of the end effector 312 which, in embodiments, would be indicative of alignment.

In some embodiments, the method may include manipulating the gladhand receptacle 116 of the trailer with the pressurized air delivered through the end effector 312. For example, and without limitation, the pressurized air may be used to pivot the gladhand receptacle 116 from a stowed condition to an open condition. In embodiments, pressurized air may be delivered through the end effector 312 or another pressurized source to force the gladhand receptacle 116 to the open deployed condition. In embodiments, the pressurized air or air jet may offer a degree of cushioning or compliance that reduces the need for accurate spatial coordination between the end effector 312 and the gladhand during deployment. A fan-shaped air jet would allow the tool to rotate the gladhand receptacle 116 90 degrees without having to rotate the jet along with it. (fan aligned with the horizontal plane and oriented such that it forces air away from the trailer, to the passenger side of the trailer, and all angles in-between.

### IV. Vehicle Systems with Gladhand Coupling and Pressure Monitoring

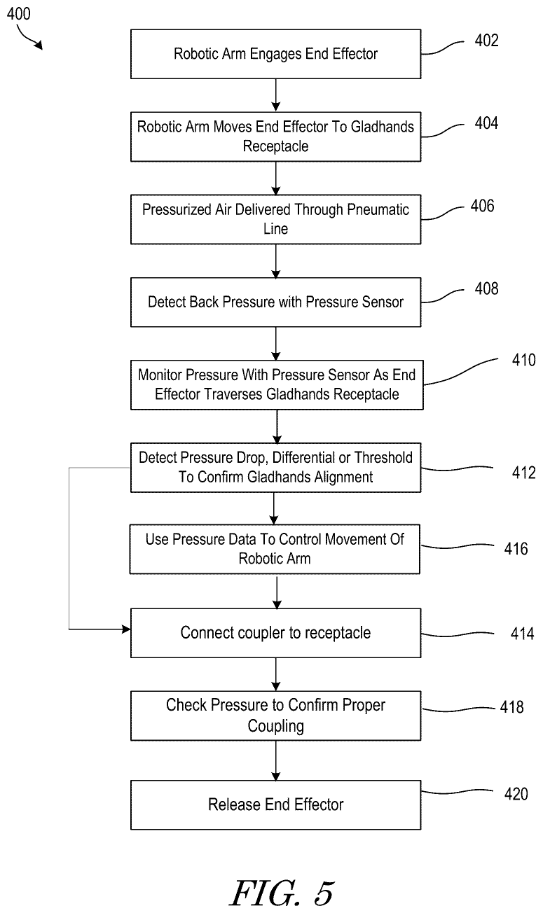

FIG. 6 illustrates an exemplary configuration of a vehicle system 500 that can facilitate autonomous, semi-autonomous operation or assisted teleoperated operation, for example, by using a robotic arm assembly to provide gladhand coupling between a towing vehicle and a towed trailer in a semiautonomous, an autonomous or an automated manner. The system 500 can include a vehicle control system 506, one or more vehicle sensors 502, a drive-by-wire system 518, an end effector 510 having one or more pressure sensors, a tool library 512, an air pressure manifold 514, a robotic arm assembly 516, an end-of-arm tool 520, and a communication unit 504. The drive-by-wire system 518 can include, for example, electrical and/or electro-mechanical components for performing one or more vehicle functions traditionally provided by mechanical linkages, e.g., braking, gearing, acceleration, and/or steering. In some embodiments, system 500 can further include one or more memories or databases. For example, system 500 can include one or more databases 508 that store driving rules (e.g., “rules of the road”) and/or a road or terrain map of an area in which the vehicle operates. Alternatively or additionally, one or more databases 508 can store details regarding one or more trailers to which the vehicle may be coupled, for example, features of gladhand receptacles of the trailers.

In some embodiments, the vehicle sensors 502 can include a navigation sensor 502a, an inertial measurement unit (IMU) 502b, an odometry sensor 502c, a RADAR system 502d, an infrared (IR) imager 502e, a visual camera 502f, a LIDAR system 502g, one or more pressure sensors 502h, one or more arm assembly sensors 502i, or any combination thereof. Other sensors are also possible according to one or more contemplated embodiments. For example, sensors 502 can further include an ultrasonic or acoustic sensor for detecting distance or proximity to objects, a compass to measure heading, inclinometer to measure an inclination of a path traveled by the vehicle (e.g., to assess if the vehicle may be subject to slippage), ranging radios (e.g., as disclosed in U.S. Pat. No. 11,234,201, incorporated herein by reference), or any combination thereof.

In some embodiments, the navigation sensor 502a can be used to determine relative or absolute position of the vehicle. For example, the navigation sensor 502a can comprise one or more global navigation satellite systems (GNSS), such as a global positioning system (GPS) device. In some embodiments, IMU 502b can be used to determine orientation or position of the vehicle. In some embodiments, the IMU 502b can comprise one or more gyroscopes or accelerometers, such as a microelectromechanical system (MEMS) gyroscope or MEMS accelerometer.

In some embodiments, the odometry sensor 502c can detect a change in position of the vehicle over time (e.g., distance). In some embodiments, odometry sensors 502c can be provided for one, some, or all of wheels of the vehicle, for example, to measure corresponding wheel speed, rotation, and/or revolutions per unit time, which measurements can then be correlated to change in position of the vehicle. For example, the odometry sensor 502c can include an encoder, a Hall effect sensor measuring speed, or any combination thereof.

In some embodiments, the RADAR system 502d can use irradiation with radio frequency waves to detect obstacles or features within an environment surrounding the vehicle. In some embodiment, the RADAR system 502d can be configured to detect a distance, position, and/or movement vector of a feature (e.g., obstacle) within the environment. For example, the RADAR system 502d can include a transmitter that generates electromagnetic waves (e.g., radio frequency or microwaves), and a receiver that detects electromagnetic waves reflected back from the environment.

In some embodiments, the IR sensor 502e can detect infrared radiation from an environment surrounding the vehicle. In some embodiments, the IR sensor 502e can detect obstacles or features in low-light level or dark conditions, for example, by including an IR light source (e.g., IR light-emitting diode (LED)) for illuminating the surrounding environment. Alternatively or additionally, in some embodiments, the IR sensor 502e can be configured to measure temperature based on detected IR radiation, for example, to assist in classifying a detected feature or obstacle as a person or vehicle.

In some embodiments, the camera sensor 502f can detect visible light radiation from the environment, for example, to determine features (e.g., obstacles) within the environment and/or features of the trailer (e.g., gladhand receptacle). For example, the camera sensor 502f can include an imaging sensor array (e.g., a charge-coupled device (CCD) or complementary metal-oxide semiconductor (CMOS) sensor) and associated optical assembly for directing light onto a detection surface of the sensor array (e.g., lenses, filters, mirrors, etc.). In some embodiments, multiple camera sensors 502f can be provided in a stereo configuration, for example, to provide depth measurements.

In some embodiments, the LIDAR sensor system 502g can include an illumination light source (e.g., laser or laser diode), an optical assembly for directing light to/from the system (e.g., one or more static or moving mirrors (such as a rotating mirror), phased arrays, lens, filters, etc.), and a photodetector (e.g., a solid-state photodiode or photomultiplier). In some embodiments, the LIDAR sensor system 502g can use laser illumination to measure distances to obstacles or features within an environment surrounding the trailer. In some embodiments, the LIDAR sensor system 502g can be configured with a field-of-view primarily directed to detect features at the rear and/or sides of the trailer. Alternatively or additionally, in some embodiments, the LIDAR sensor system 502g can be used to identify the loading dock and/or measure features thereof. Alternatively or additionally, in some embodiments, the LIDAR sensor system 502g can be configured to provide three-dimensional imaging data of the environment, and the imaging data can be processed (e.g., by the LIDAR system itself or by a module of control system 506) to generate a view of the environment (e.g., at least a 180-degree view, a 270-degree view, or a 360-degree view).

In some embodiments, the pressure sensor 502h may include the pressure sensor 352 descried hereinabove such as a piezoresistive sensor, capacitive pressure transducer, pressure transducer, differential pressure transducer, gauge pressure, differential pressure sensor. The pressure sensor 502h is configured to detect the pressure of fluid, for example, air adjacent the end effector 510, for example, adjacent the mating faces of the end effector 510 and the gladhand receptacle 116 of the trailer. The pressure data obtained by the pressure sensor 502h is used to properly align and/or confirm alignment of the end effector 510 relative to the gladhand receptacle 116 of the trailer.

In some embodiments, arm sensor 502i can comprise a linear encoder, a rotary encoder, or any combination thereof. Alternatively or additionally, in some embodiments, the arm sensor 502i can measure location of the gladhand receptacle with respect to the end effector, for example, to assist in alignment between the end effector and the gladhand receptacle. For example, the arm sensor 502i can include an optical detector to image the pneumatic port and/or sealing member of the gladhand receptacle, and optionally part of the end effector that interfaces with the pneumatic port and/or sealing member. The arm sensor 502i may include a force configured to measure forces applied to the robotic arm assembly 516 and/or an end effector 510, for example, to measure a clamping force applied by the end effector 510 to the corresponding gladhand receptacle. In some embodiments, the force sensor can comprise a strain gauge, a piezoelectric sensor, a capacitive sensor, an inductive sensor, a load cell, or any combination thereof. In some embodiments, the arm sensor 502i can measure characteristics of the robotic arm assembly 516 and/or end effector 510, for example, a position of a robotic arm and/or displacement of linear actuators.

The vehicle sensors 502 can be operatively coupled to the control system 506, such that the control system 506 can receive data signals from the sensors 502 and control operation of the vehicle (e.g., hostler), or components thereof (e.g., drive-by-wire system 518, communication unit 504, end effector 510 having a pressure sensor, tool library 512, manifold 514, and/or robotic arm assembly 516), responsively thereto. For example, FIG. 6 shows a configuration of a control system 506 that includes, in accordance with some embodiments, one or more modules, programs, software engines or processor instructions for performing at least some of the functionalities described herein.

FIG. 6 shows a configuration of a control system 506 that includes, in accordance with some embodiments, one or more modules, programs, software engines or processor instructions for performing at least some of the functionalities described herein. For example, control system 506 may comprise one or more software module(s) or engine(s) for directing one or more processors of system 500 to perform certain functions. In some embodiments, software components, applications, routines or sub-routines, or sets of instructions for causing one or more processors to perform certain functions may be referred to as “modules” or “engines.” It should be noted that such modules or engines, or any software or computer program referred to herein, may be written in any computer language and may be a portion of a monolithic code base, or may be developed in more discrete code portions, such as is typical in object-oriented computer languages. In addition, the modules or engines, or any software or computer program referred to herein, may in some embodiments be distributed across a plurality of computer platforms, servers, terminals, and the like. For example, a given module or engine may be implemented such that the described functions are performed by separate processors and/or computing hardware platforms. Further, although certain functionality may be described as being performed by a particular module or engine, such description should not be taken in a limiting fashion. In other embodiments, functionality described herein as being performed by a particular module or engine may instead (or additionally) be performed by a different module, engine, program, sub-routine or computing device without departing from the spirit and scope of the invention(s) described herein.

It should be understood that any of the software modules, engines, or computer programs illustrated herein may be part of a single program or integrated into various programs for controlling one or more processors of a computing device or system. Further, any of the software modules, engines, or computer programs illustrated herein may be stored in a compressed, uncompiled, and/or encrypted format and include instructions which, when performed by one or more processors, cause the one or more processors to operate in accordance with at least some of the methods described herein. Of course, additional and/or different software modules, engines, or computer programs may be included, and it should be understood that the examples illustrated and described with respect to FIG. 6 are not necessary in any embodiments. Use of the terms “module” or “software engine” is not intended to imply that the functionality described with reference thereto is embodied as a stand-alone or independently functioning program or application. While in some embodiments functionality described with respect to a particular module or engine may be independently functioning, in other embodiments such functionality is described with reference to a particular module or engine for case or convenience of description only and such functionality may in fact be a part of, or integrated into, another module, engine, program, application, or set of instructions for directing a processor of a computing device.

In some embodiments, the instructions of any or all of the software modules, engines or programs described above may be read into a main memory from another computer-readable medium, such from a read-only memory (ROM) to random access memory (RAM). Execution of sequences of instructions in the software module(s) or program(s) can cause one or more processors to perform at least some of the processes or functionalities described herein. Alternatively or additionally, in some embodiments, hard-wired circuitry may be used in place of, or in combination with, software instructions for implementation of the processes or functionalities described herein. Thus, the embodiments described herein are not limited to any specific combination of hardware and software.

In the illustrated example of FIG. 6, the control system 506 includes a receptacle identification module 506a, an arm path planning module 506b, and a pneumatic pressure module 506c. In some embodiments, the receptacle identification module 506a can be configured to automatically identify features of a gladhand receptacle for coupling thereto. For example, the receptacle identification module 506a can identify the type of the gladhand receptacle (e.g., for selecting an appropriate end effector configuration and/or end effector), identify a location of the gladhand receptacle (e.g., a location of the pneumatic port and/or sealing member), and/or determine an orientation of the gladhand receptacle (e.g., stowed position and/or deviation from a standard coupling orientation). In some embodiments, the receptacle identification module 506a can identify a gripping portion of the gladhand receptacle, for example, detent plate 130. In some embodiments, the receptacle identification module 506a can further determine a distance between an identified vertical feature (e.g., hinge or joint) and a portion of the round gladhand receptacle.

In some embodiments, the arm path planning module 506b can plan a path for the end effector and/or the robotic arm assembly connected thereto. The arm path planning module 506b can plan a path from an initial stowed position proximal to the rear of the vehicle (e.g., when the end effector was already held by the arm assembly) to a final coupling position, where an outlet of the end effector aligned with the pneumatic port of the gladhand receptacle.

Alternatively or additionally, in some embodiments, the path can be planned from an end effector selection position (e.g., via tool library 512) to the final coupling position. Alternatively or additionally, the path can be planned from an initial stowed position to an end effector selection position and then on to the final coupling position. Alternatively or additionally, the path can be planned by module 506b for the end effector (and/or the robotic arm assembly connected thereto) to rotate the gladhand receptacle to a coupling position. In some embodiments, the arm path planning module 506b can plan a return path of the robotic arm assembly without the end effector (e.g., after the end effector has been successfully coupled to the receptacle and thus released from the arm assembly), for example, to a stowed position. In some embodiments, the planning can be such that the path avoids moving or stationary obstacles. In some embodiments, the arm path planning module 506b can control the robotic arm assembly 516 to follow the planned path, and/or actuate the end effector 510 to engage the gladhand receptacle.

In some embodiments, the pressure sensor module 506c is in communication with the pressure sensor 502h, and is configured to collect and process data obtained by the pressure sensor 502h to facilitate alignment and coupling of the end effector 510 to the gladhand receptacle of the trailer. In embodiments, the pressure sensor module 506c includes one or more algorithms or models to process the pressure data and determine a pressure differential or change between successive sensor readings and/or identify a pressure threshold indicative of alignment of the pneumatic ports of the end effector and the gladhand receptacle. In some embodiments, the pressure sensor module 506c is coupled to other modules of the control system 506, for example, the arm path planning module 506b, to enable/facilitate operation of the robotic arm based on the detected pressure readings. In some embodiments, the pressure sensor module 506c is independent of the vehicle control system 506.

The control system 506 can also include an obstacle detection module 506d, a route planning module 506e, and/or a drive control module 506f. Other modules or components are also possible according to one or more contemplated embodiments. In some embodiments, the route planning module 506d can be configured to plan a route for the vehicle to follow. In some embodiments, the route planning module 506d can employ data stored in database 508 regarding rules of the road and/or the road network or area to plan a route while avoiding known or detected obstacles in the environment. In some embodiments, the control system 506 can use signals from the sensors 502 to identify traversable paths through the area, for example, using vehicle position and/or features identified in the surrounding environment by one or more of sensors 502. In some embodiments, drive control module 506f can then control the drive-by-wire system 518 (e.g., an electrical or electro-mechanical system that controls steering, gearing, velocity, acceleration, and/or braking) to have the vehicle (e.g., with trailer coupled thereto) follow the planned route. Alternatively or additionally, in some embodiments, the control system 506 can control the drive-by-wire system 518 based one or more signals received via communication unit 504 (e.g., transceiver for wireless communication), for example, to follow another vehicle (e.g., autonomous or manually-operated leader vehicle). In some embodiments, the obstacle detection module 506e can be configured to detect obstacles (e.g., impassable road features, other vehicles, pedestrians, etc.) as the vehicle moves. Control system 506 can be further configured to avoid the detected obstacles, for example, by instructing the vehicle to follow an alternative path.

In some embodiments, the vehicle can communicate with other vehicles and/or a communication infrastructure (e.g., cellular network) via communication unit 504. Alternatively or additionally, the communication unit 504 can communicate instructions to and/or receive signals from an end effector coupled to the gladhand receptacle of the trailer, for example, to control coupling operation thereof. In some embodiments, the communication unit employs a wireless communication modality, such as radio, ultra-wideband (UWB), Bluetooth, Wi-Fi, cellular, optical, or any other wireless communication modality.

### V. Computer Implementation

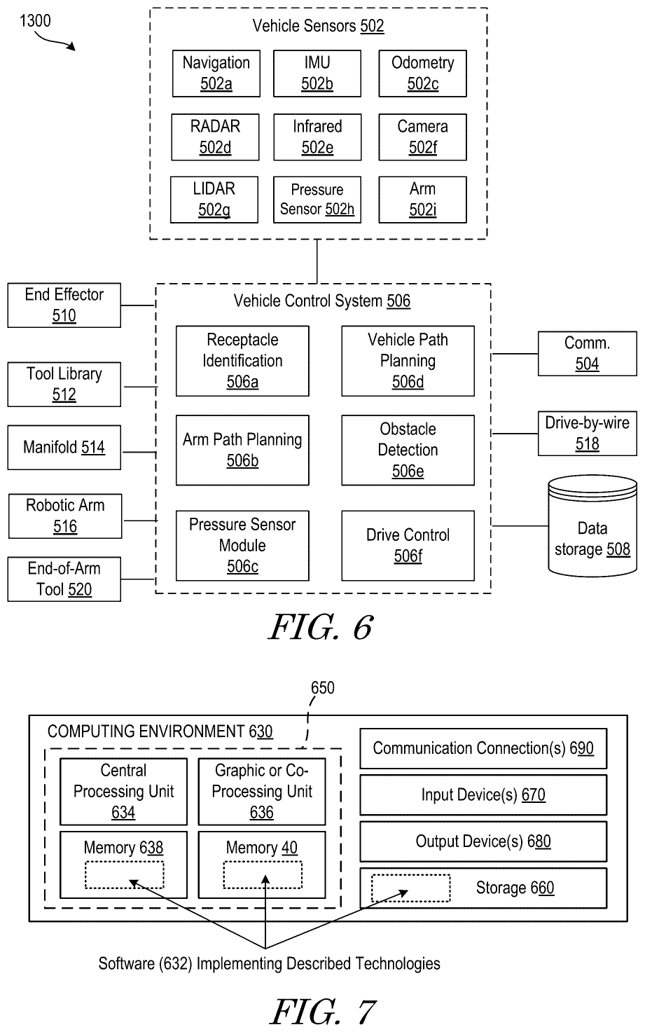

FIG. 7 depicts a generalized example of a suitable computing environment 630 in which the described innovations may be implemented. The computing environment 630 is not intended to suggest any limitation as to scope of use or functionality, as innovations may be implemented in diverse general-purpose or special-purpose computing systems. For example, computing environment 630 can be any of a variety of computing devices (e.g., desktop computer, laptop computer, server computer, tablet computer, etc.).

In the illustrated example, the computing environment 630 includes one or more processing units 634, 636 and one or more memories 638, 640, with this base configuration 650 included within a dashed line. The processing units 634, 636 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 7 shows a central processing unit 634 as well as a graphics processing unit or co-processing unit 636. The tangible memory 638, 640 may be volatile memory (e.g., registers, cache, RAM), non-volatile memory (e.g., ROM, EEPROM, flash memory, etc.), or some combination of the two, accessible by the processing unit(s). The memory 638, 640 stores software 632 implementing one or more innovations described herein, in the form of computer-executable instructions suitable for execution by the processing unit(s).

A computing system may have additional features. For example, the computing environment 630 includes one or more storage 660, one or more input devices 670, one or more output devices 680, and one or more communication connections 690. An interconnection mechanism (not shown) such as a bus, controller, or network interconnects the components of the computing environment 630. In some embodiments, an operating system software (not shown) can provide an operating environment for other software executing in the computing environment 630 and can coordinate activities of the components of the computing environment 630.

The tangible storage 660 may be removable or non-removable, and includes magnetic disks, magnetic tapes or cassettes, CD-ROMs, DVDs, or any other medium which can be used to store information in a non-transitory way, and which can be accessed within the computing environment 630. The storage 660 can store instructions for the software 1432 implementing one or more innovations described herein.

The input device(s) 670 may be a touch input device such as a keyboard, mouse, pen, or trackball, a voice input device, a scanning device, or another device that provides input to the computing environment 630. The output device(s) 670 may be a display, printer, speaker, CD-writer, or another device that provides output from computing environment 630.

The communication connection(s) 690 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Python, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### VI. Additional Examples of the Disclosed Technology

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A method, comprising:
positioning a gladhand coupler of a vehicle adjacent a gladhand receptacle of a trailer;
delivering pressurized fluid through a pneumatic channel and out a pneumatic port of the gladhand coupler to impinge upon the gladhand receptacle;
detecting, with a pressure sensor, back pressure of the delivered fluid reflected off the gladhand receptacle;
determine a location of a pneumatic port of the gladhand receptacle based at least in part on one of a detected threshold pressure, detected pressure differential or detected pressure change of the back pressure to enable alignment of the pneumatic port of the gladhand coupler relative to the pneumatic port of the gladhand receptacle; and coupling the gladhand coupler to the gladhand receptacle.

Clause 2. The method according to clause 1 including coupling an end effector to a robotic arm, the end effector including the gladhand coupler.

Clause 3. The method according to clause 2 wherein coupling the gladhand coupler to the gladhand receptacle includes aligning the pneumatic ports of the gladhand coupler and the gladhand receptacle.

Clause 4. The method according to clause 3 wherein coupling the gladhand coupler to the gladhand receptacle includes engaging pneumatic seals of the gladhand coupler and the gladhand receptacle.

Clause 5. The method according to clause 4 wherein detecting the location of the pneumatic port of the gladhand receptacle includes identifying a seal aperture of the pneumatic seal of the gladhand receptacle based on the one of the detected threshold pressure, detected pressure differential or detected pressure change of the back pressure.

Clause 6. The method according to clause 5 wherein coupling the gladhand coupler to the gladhand receptacle is performed semi-autonomously or assisted teleoperated operation with the robotic arm.

Clause 7. The method according to clause 5 wherein coupling the gladhand coupler to the gladhand receptacle is performed autonomously with the robotic arm.

Clause 8. The method according to clause 7 including controlling movement of the robotic arm based at least in part of pressure data detected by the pressure sensor.

Clause 9. The method according to clause 5 including verifying a sealed relationship of the engaged pneumatic seals of the gladhand coupler and the gladhand receptacle.

Clause 10. The method according to clause 5 including releasing the end effector from the robotic arm.

Clause 11. A method, comprising:
coupling an end effector to a robotic arm, the end effector including a gladhand coupler defining a first pneumatic channel and a first pneumatic port for passage of pressurized air from a pressurized line of a vehicle, and having a first pneumatic seal defining a first seal opening surrounding the first pneumatic port;
moving the robotic arm to position the end effector adjacent a gladhand receptacle of a trailer, the gladhand receptacle having a second pneumatic seal defining a second seal opening surrounding a second pneumatic port of the gladhand receptacle;
delivering pressurized air from the pressurized line through the first pneumatic channel and out the first pneumatic port of the gladhand coupler to impinge upon the gladhand receptacle;
detecting, with a pressure sensor, back pressure of the delivered air;
identifying a location of the second seal opening of the pneumatic seal of the gladhand receptacle based at least in part on one of a threshold pressure, pressure differential or pressure change of the detected back pressure;
aligning the first pneumatic port of the gladhand coupler with the second pneumatic port of the gladhand receptacle; and
coupling the gladhand coupler to the gladhand receptacle whereby the first and second pneumatic seals establish a sealed relation.

Clause 12. The method according to clause 11 including releasing the end effector from the robotic arm.

Clause 13. The method according to clause 11 including moving the end effector relative to the gladhand receptacle.

Clause 14. The method according to clause 13 wherein obtaining multiple pressure measurements with the pressure sensor.

Clause 15. The method according to clause 14 wherein at least one of the steps is performed by a processor and a memory coupled to the processor.

Clause 16. A gladhand coupler system for attachment to a gladhand of a trailer, which comprises:
a robotic apparatus including at least one robotic arm and having an end effector coupled to the robotic arm;
a gladhand coupler mounted to the end effector of the robotic system;
a pneumatic channel extending at least through the gladhand coupler and terminating in a pneumatic port for delivering pressurized fluids from the port toward the gladhand receptacle of the trailer;
a pressure sensor module including a pressure sensor for detecting back pressure of the pressurized fluids reflected off the gladhand receptacle;
an electronic processing device; and
a non-transitory computable-reading medium storing instruction that when executed by the electronic processing device results in:
activating the at least one robotic arm to move the end effector to position the gladhand coupler adjacent the gladhand receptacle of the trailer; and
adjust a location of the gladhand coupler via the at least one robotic arm based at least in part on a detected back pressure of the pressurized fluids off the gladhand receptacle detected by the pressure sensor.

Clause 17. The gladhand coupler system according to clause 16 wherein the instructions, when executed by the electronic processing device, further results in:
identifying a seal aperture of the pneumatic seal of the gladhand receptacle based on the detected back pressure.

Clause 18. The gladhand coupler system according to clause 17 wherein the instructions, when executed by the electronic processing device, further results in:
manipulating the at least one robotic arm and the end effector to align pneumatic ports of the gladhand coupler and the gladhand receptacle.

Clause 19. The gladhand coupler system according to clause 18 wherein the instructions, when executed by the electronic processing device, further results in:
coupling, by the at least one robotic arm and the end effector, the gladhand coupler to the gladhand receptacle.

Clause 20. The gladhand coupler system according to clause 19 wherein coupling the gladhand coupler includes engaging pneumatic seals of the gladhand coupler and the gladhand receptacle.

### VII. Rules of Interpretation

Throughout the description herein and unless otherwise specified, the following terms may include and/or encompass the example meanings provided. These terms and illustrative example meanings are provided to clarify the language selected to describe embodiments both in the specification and in the appended points of focus, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments. A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required. Although a product may be described as including a plurality of components, aspects, qualities, characteristics and/or features, that does not indicate that all of the plurality are essential or required. Various other embodiments within the scope of the described invention(s) include other products that omit some or all of the described plurality. A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Neither the Title (set forth at the beginning of the first page of this patent application) nor the Abstract (set forth at the end of this patent application) is to be taken as limiting in any way as the scope of the disclosed invention(s). Headings of sections provided in this patent application are for convenience only, and are not to be taken as limiting the disclosure in any way.

All definitions, as defined and used herein, should be understood to control over dictionary definitions, definitions in documents incorporated by reference, and/or ordinary meanings of the defined terms. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the clauses. Accordingly, the clauses are intended to cover all such equivalents.

The term “product” means any machine, manufacture and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise. Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A reference to “another embodiment” in describing an embodiment does not imply that the referenced embodiment is mutually exclusive with another embodiment (e.g., an embodiment described before the referenced embodiment), unless expressly specified otherwise.

The indefinite articles “a” and “an,” as used herein in the specification and in the clauses, unless clearly indicated to the contrary, should be understood to mean “at least one” or “one or more”.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” claim, whether related or unrelated to those elements specifically identified, unless clearly indicated to the contrary.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods, as known to those of ordinary skill in the art. When directly and explicitly distinguishing embodiments from discussed prior art, the embodiment numbers are not approximates unless the word “about” is recited. Whenever “substantially,” “approximately,” “about,” or similar language is explicitly used in combination with a specific value, variations up to and including ten percent (10%) of that value are intended, unless explicitly stated otherwise.

Directions and other relative references may be used to facilitate discussion of the drawings and principles herein, but are not intended to be limiting. For example, certain terms may be used such as “inner,” “outer”, “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same. Similarly, while the terms “horizontal” and “vertical” may be utilized herein, such terms may refer to any normal geometric planes regardless of their orientation with respect to true horizontal or vertical directions (e.g., with respect to the vector of gravitational acceleration).

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Where a limitation of a first clause would cover one of a feature as well as more than one of a feature (e.g., a limitation such as “at least one widget” covers one widget as well as more than one widget), and where in a second clause that depends on the first clause, the second clause uses a definite article “the” to refer to the limitation (e.g., “the widget”), this does not imply that the first clause covers only one of the feature, and this does not imply that the second clause covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

“Determining” something can be performed in a variety of manners and therefore the term “determining” (and like terms) includes calculating, computing, deriving, looking up (e.g., in a table, database or data structure), ascertaining and the like. The term “computing” as utilized herein may generally refer to any number, sequence, and/or type of electronic processing activities performed by an electronic device, such as, but not limited to looking up (e.g., accessing a lookup table or array), calculating (e.g., utilizing multiple numeric values in accordance with a mathematic formula), deriving, and/or defining.

The terms “including”, “comprising” and variations thereof mean “including but not limited to”, unless expressly specified otherwise. As used herein, “comprising” means “including,” and the singular forms “a” or “an” or “the” include plural references unless the context clearly dictates otherwise. The term “or” refers to a single element of stated alternative elements or a combination of two or more elements, unless the context clearly indicates otherwise.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications.

Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media, such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as ultra-wideband (UWB) radio, Bluetooth™, Wi-Fi, TDMA, CDMA, 3G, 4G, 4G LTE, 5G, etc.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

Embodiments of the disclosed subject matter can be configured to work in a network environment including a computer that is in communication, via a communications network, with one or more devices. The computer may communicate with the devices directly or indirectly, via a wired or wireless medium, such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

### VIII. Conclusion

Although particular vehicles, trailers, sensors, components, and configuration have been illustrated in the figures and discussed in detail herein, embodiments of the disclosed subject matter are not limited thereto. Indeed, one of ordinary skill in the art will readily appreciate that different vehicles (e.g., any vehicle where gladhand connections are used), trailers (e.g., tanker trailers, flat-bed trailer, reefer trailer, box trailer, etc.), sensors, components, or configurations can be selected and/or components added to provide the same effect. In practical implementations, embodiments may include additional components or other variations beyond those illustrated. Accordingly, embodiments of the disclosed subject matter are not limited to the particular vehicles, trailers, sensors, components, and configurations specifically illustrated and described herein.

Any of the features illustrated or described with respect to one of the Figures and Clauses can be combined with features illustrated or described with respect to any other of Figures and Clauses to provide systems, methods, devices, and embodiments not otherwise illustrated or specifically described herein. All features described herein are independent of one another and, except where structurally impossible, can be used in combination with any other feature described herein.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant intends to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the present disclosure.

What is claimed is:

1. A method, comprising:
positioning a gladhand coupler of a vehicle adjacent a gladhand receptacle of a trailer;
delivering pressurized fluid through a pneumatic channel and out a pneumatic port of the gladhand coupler to impinge upon the gladhand receptacle;
detecting, with a pressure sensor, back pressure of the pressurized fluid reflected off the gladhand receptacle;
determine a location of a pneumatic port of the gladhand receptacle based at least in part on one of a detected threshold pressure, detected pressure differential or detected pressure change of the back pressure to enable alignment of the pneumatic port of the gladhand coupler relative to a pneumatic port of the gladhand receptacle; and
coupling the gladhand coupler to the gladhand receptacle.

2. The method according to claim 1 including coupling an end effector to a robotic arm, the end effector including the gladhand coupler.

3. The method according to claim 2 wherein coupling the gladhand coupler to the gladhand receptacle includes aligning the pneumatic ports of the gladhand coupler and the gladhand receptacle.

4. The method according to claim 3 wherein coupling the gladhand coupler to the gladhand receptacle includes engaging pneumatic seals of the gladhand coupler and the gladhand receptacle.

5. The method according to claim 4 wherein detecting the location of the pneumatic port of the gladhand receptacle includes identifying a seal aperture of the pneumatic seal of the gladhand receptacle based on the one of the detected threshold pressure, detected pressure differential or detected pressure change of the back pressure.

6. The method according to claim 5 wherein coupling the gladhand coupler to the gladhand receptacle is performed semi-autonomously with the robotic arm.

7. The method according to claim 5 wherein coupling the gladhand coupler to the gladhand receptacle is performed autonomously with the robotic arm.

8. The method according to claim 7 including controlling movement of the robotic arm based at least in part of pressure data detected by the pressure sensor.

9. The method according to claim 5 including verifying a sealed relationship of the engaged pneumatic seals of the gladhand coupler and the gladhand receptacle.

10. The method according to claim 5 including releasing the end effector from the robotic arm.

11. A method, comprising:
coupling an end effector to a robotic arm, the end effector including a gladhand coupler defining a first pneumatic channel and a first pneumatic port for passage of pressurized air from a pressurized line of a vehicle, and having a first pneumatic seal defining a first seal opening surrounding the first pneumatic port;
moving the robotic arm to position the end effector adjacent a gladhand receptacle of a trailer, the gladhand receptacle having a second pneumatic seal defining a second seal opening surrounding a second pneumatic port of the gladhand receptacle;
delivering pressurized air from the pressurized line through the first pneumatic channel and out the first pneumatic port of the gladhand coupler to impinge upon the gladhand receptacle;
detecting, with a pressure sensor, back pressure of the delivered air;
identifying a location of the second seal opening of the pneumatic seal of the gladhand receptacle based at least in part on one of a threshold pressure, pressure differential or pressure change of the detected back pressure;
aligning the first pneumatic port of the gladhand coupler with the second pneumatic port of the gladhand receptacle; and
coupling the gladhand coupler to the gladhand receptacle whereby the first and second pneumatic seals establish a sealed relation.

12. The method according to claim 11 including releasing the end effector from the robotic arm.

13. The method according to claim 11 including moving the end effector relative to the gladhand receptacle.

14. The method according to claim 13 wherein obtaining multiple pressure measurements with the pressure sensor.

15. The method according to claim 14 wherein at least one of the steps is performed by a processor and a memory coupled to the processor.

16. A gladhand coupler system for attachment to a gladhand receptacle of a trailer, which comprises:
a robotic apparatus including at least one robotic arm and having an end effector coupled to the robotic arm;
a gladhand coupler mounted to the end effector of the robotic system;
a pneumatic channel extending at least through the gladhand coupler and terminating in a pneumatic port for delivering pressurized fluids from the port toward a gladhand receptacle of the trailer;
a pressure sensor module including a pressure sensor for detecting back pressure of the pressurized fluids reflected off the gladhand receptacle;
an electronic processing device; and
a non-transitory computable-reading medium storing instruction that when executed by the electronic processing device results in:
activating the at least one robotic arm to move the end effector to position the gladhand coupler adjacent the gladhand receptacle of the trailer; and
adjust a location of the gladhand coupler via the at least one robotic arm based at least in part on a detected back pressure of the pressurized fluids off the gladhand receptacle detected by the pressure sensor.

17. The gladhand coupler system according to claim 16 wherein the instructions, when executed by the electronic processing device, further results in:
identifying a seal aperture of a pneumatic seal of the gladhand receptacle based on the detected back pressure.

18. The gladhand coupler system according to claim 17 wherein the instructions, when executed by the electronic processing device, further results in:
manipulating the at least one robotic arm and the end effector to align pneumatic ports of the gladhand coupler and the gladhand receptacle.

19. The gladhand coupler system according to claim 18 wherein the instructions, when executed by the electronic processing device, further results in:
coupling, by the at least one robotic arm and the end effector, the gladhand coupler to the gladhand receptacle.

20. The gladhand coupler system according to claim 19 wherein coupling the gladhand coupler includes engaging pneumatic seals of the gladhand coupler and the gladhand receptacle.
